(19) United States
(12) Patent Application Publication
(10) Pub. No.: US 2011/0098924 A1
(43) Pub. Date: Apr. 28, 2011

(54) METHOD AND DEVICE FOR DETERMINING A DISTANCE

(75) Inventors: JOSEPH BALARDETA, ENCINITAS, CA (US); SCOTT DENTON, CARLSBAD, CA (US)

(73) Assignee: CALLAWAY GOLF COMPANY, CARLSBAD, CA (US)

(21) Appl. No.: 12/607,203

(22) Filed: Oct. 28, 2009

(51) Int. Cl. G01C 21/00; G01C 3/08

(52) U.S. Cl. 701/213; 356/4.01

(57) ABSTRACT

A device and method for determining a distance from the device to a distant point is disclosed herein. The device includes a GPS component, a laser component, a camera component, a memory, a display component, a user input, and a processor comprising means for determining a distance between any two points.

### CROSS REFERENCES TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The field of the invention generally relates to electronic devices which utilize the global positioning system (“GPS”) to determine locations and distances, and more particularly to a GPS device for determining distances to features on a golf course, and displaying the distances to features, golf course images, and/or other golf related data.

2. Description of the Related Art

In golf, there is always a need for more information. Knowing more information about the course being played gives players of all abilities a better chance to improve their game or make the right shot choice. Standard golf GPS provides distance to the front, middle and back of the green. This is typically not enough information for players to make the best choices. Having the ability to measure to or from anything on the golf course provides detailed information which quickly becomes indispensable.

Currently, the only competing solutions allow either movement limited only to the Green, or in another case, allows movement of a measurement point around a representation of the hole however does not allow measurement to or from anything on the course. In the former case, a crosshair can be moved around the area of the green, allowing limited functionality. In the latter case, the cursor movement covers the whole course, however the measurement is always from the current user location to the cursor, and from the cursor to a selected point on the green.

Various golf GPS devices, both handheld and golf cart-mounted, have been previously disclosed and described in the prior art. Generally, these devices comprise a GPS receiver and processing electronics (the “GPS system”), a display such as a liquid crystal display (“LCD”) or cathode ray tube (“CRT”), and a user input device such as a keypad. Golf course data is input and stored in the golf GPS device, including for example, the coordinates for locations of greens, bunkers and/or other course features. These types of devices use the GPS system to determine the location of the device. Then, the device calculates and displays the distances to the various golf course features, such as the distance to the front, middle and back of the green, or the distance to a bunker or water hazard. Accordingly, by placing the device at or near the golfer's ball, the device can relatively easily and accurately provide the golfer with important distance information usable while playing golf. For example, the distance information is used by the golfer to formulate strategy for playing a hole (sometimes called “course management”) and for club selection.

An example of a handheld golf GPS device is the SKYCADDIE line of devices from SKYGOLF. At present, there are four models of SKYCADDIES with various levels of functionality and features. The golf course data is loaded into the SKYCADDIE device. As described by Skygolf, the golf course data is generated by mapping each course on the ground using GPS and survey equipment. The database of golf course data is accessible through the internet on SKYCADDIE's website. The golf course data is downloaded onto a PC and then may be loaded onto the SKYCADDIE device by connecting the device to the PC. In addition, the SKYCADDIE devices allow a user to map a course, or additional course features, in the event a course or feature of interest is not included in the Skygolf database.

Certain models of the SKYCADDIEs may also display an outline of the green for a selected hole with the distances to the front, center and back of green displayed to the side of the displayed outline. Some models also display an icon representation of certain features, such as a creek, bunker or green, in one section of the display and the distances to such features in a different section of the display next to the icons. The SKYCADDIE devices can only measure distance to locations which are not pre-stored in the course data by marking a starting location and then moving the device to the measured location and marking the ending location. The device will then display the distance between the two locations. However, this requires walking all the way to the measured location. The SKYCADDIE devices are configured to automatically advance to the next hole of play based on the location of the device.

However, none of the previously described golf GPS devices provides a convenient, pocket-sized form factor, a high-resolution color display capable of displaying photographic images of a golf course, flexible calibration to improve accuracy, or the functionality and ease of use to take full advantage of such features. Accordingly, there is a need for an improved golf GPS device which overcomes the deficiencies and drawbacks of previous devices and systems.

### BRIEF SUMMARY OF THE INVENTION

One aspect of the present invention is a device for determining a distance from the device to a distant point. The device preferably comprises a GPS component, a laser component, a camera component, a display component, a processor and a power source. The device utilizes the GPS component to provide a location of the device. The device utilizes the camera component to enhance viewing of an object located at a distant point. The device utilizes the laser component to measure a distance from the device to the object located at the distant point.

The portable golf GPS device of the present invention generally comprises a microprocessor operably coupled to a GPS unit, an input device such as a keypad (or touch screen) operably coupled to the microprocessor, and a display such as a liquid crystal display (“LCD”) operably coupled to the microprocessor. A program memory system which contains at least some of the software and data to operate the device is also operably coupled to the microprocessor. The device also comprises various firmware and software configured to control the operation of the device and provide the device functionality as described in more detail below. In addition, data utilized by the device, such as golf course data and images, may be stored in the program memory or other memory module such as Secure Digital memory card (“SD Card”), USB based memory devices, other types of flash memory, or the like.

For portability, the golf GPS device of the present invention is self-contained, compact and lightweight. For example, the device is preferably battery operated. The portable golf GPS device is preferably contained in a housing such that the entire device has a very compact and lightweight form factor, and is preferably handheld and small enough to fit comfortably in a pocket of a user's clothing. For example, the entire golf GPS device may be 4 inches long (4″), by 2 inches wide (2″), by 0.6 inches thick (0.6″), or smaller in any one or more of the dimensions. The entire golf GPS device may weigh 3.5 ounces or less, including the battery.

The microprocessor may be any suitable processor, such as one of the MX line of processors available from Freescale Semiconductor or other ARM based microprocessor. The GPS unit may be any suitable GPS microchip or chipset, such as the NJ1030/NJ1006 GPS chipset available from Nemerix, Inc. The LCD is preferably a high resolution (e.g. 320 pixels by 240 pixels, QVGA or higher resolution), full color LCD, having a size of about 2.2″ diagonal

The program memory may include one or more electronic memory devices on the golf GPS device. For example, the program memory may include some memory contained on the microprocessor, memory in a non-volatile memory storage device such as flash memory, EPROM, or EEPROM, memory on a hard disk drive (“hdd”), SD Card(s), USB based memory devices, other types of flash memory, or other suitable storage device. The program memory stores at least some of the software configured to control the operation of the device and provide the functionality of the golf GPS device.

The components of the portable golf GPS device are preferably assembled onto a PCB, along with various other electronic components used to control and distribute the battery power, thereby providing the electronic connections and operability for a functional electronic device.

The hardware and software of the portable golf GPS device are configured to determine, track, and display useful golf related information, before, during and after a round of golf. For example, the GPS device is configured to store golf course data for a particular golf course of interest which is loaded onto the GPS device in any suitable manner. The golf course data includes geographic location coordinates for various golf course features, such as bunkers, greens, water hazards, tees, and the like. The golf course data may also include golf hole data such a par, handicap, daily tee and hole locations, etc. In addition, the golf course data may include photographic course images, such as satellite or aerial photographs and/or video images.

### BRIEF DESCRIPTION OF THE SEVERAL VIEWS OF THE DRAWINGS

FIG. 1 is a schematic block diagram of a device according to one embodiment of the present invention.

FIG. 1A is a schematic block diagram of a device according to one embodiment of the present invention.

FIG. 2 is a four view showing the front, left side, right side, top and bottom of a golf GPS device according to one embodiment of the present invention.

FIG. 3 is front, elevational view of a GPS device with a Main Menu displayed on the display according to one embodiment of the present invention.

FIG. 4 is front, elevational view of a GPS device with a Golf Menu displayed on the display according to one embodiment of the present invention.

FIG. 5 is front, elevational view of a GPS device with golf hole information displayed on the display according to one embodiment of the present invention.

FIG. 6 is front, elevational view of a GPS device with a Hazard view in Basic Mode displayed on the display according to one embodiment of the present invention.

FIG. 7 is front, elevational view of a GPS device with a Pro Mode view displayed on the display according to one embodiment of the present invention.

FIG. 8 is front, elevational view of a GPS device with another Pro Mode view displayed on the display according to one embodiment of the present invention.

FIG. 9 is front, elevational view of a GPS device with a zoomed in Pro Mode view displayed on the display according to one embodiment of the present invention.

FIG. 10 is front, elevational view of a GPS device in a Measure mode displayed on the display according to one embodiment of the present invention.

FIG. 11 is front, elevational view of a GPS device with another aspect of the Measure mode displayed on the display according to one embodiment of the present invention.

FIG. 12 is a rear plan view of a device of the present invention.

FIG. 13 is an illustration of a golfer utilizing a device to measure the distance to a flag stick in the distance.

FIG. 14 is an illustration of the imaging process showing a real image of a flagstick, a camera image of the flagstick, a high resolution display of the flagstick on the device, a laser shot image of the flagstick and an aerial image of the location of the flagstick.

### DETAILED DESCRIPTION OF THE INVENTION

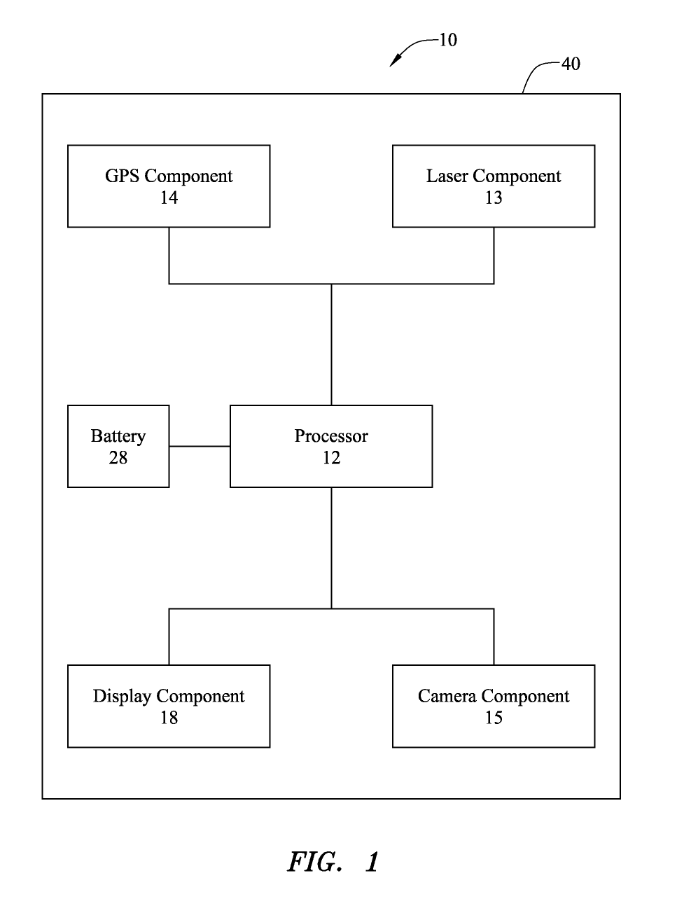

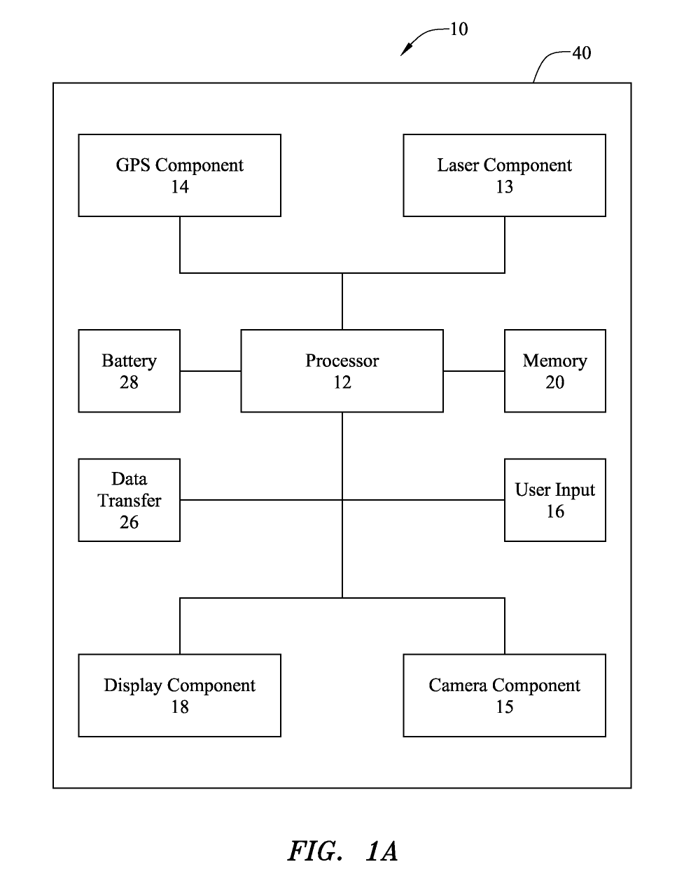

As shown in FIG. 1, the device 10 preferably comprises a housing 40 containing a processor 12, a laser component 13, a GPS component 14, a camera component 15, a display component 18 and a battery 28. The laser component 13 preferably comprises a light source and a receiver. The GPS component 14 preferably comprises a receiver and an antenna. The display component 18 is preferably a LCD.

Referring to FIG. 1A, a schematic block diagram of the major electronic components of a device 10 according to an alternative embodiment. The device 10 preferably comprises a processor 12 which is operably coupled to a laser component 13, a GPS component 14, a camera component 15, a user input device 16, a display component 18; a program memory 20, a data transfer interface 26, and a battery and power management unit 28. As understood by one of ordinary skill in the art, the device 10 also comprises other electronic components, such as passive electronics and other electronics configured to produce a fully functional device as described herein. In addition, the device 10 comprises various firmware and software configured to control the operation of the device 10 and provide the device functionality as described in more detail below.

The processor 12 is preferably an ARM based microprocessor, such as one of the MX line of processors available from Freescale Semiconductor, but may be any other suitable processor. The processor 12 executes instructions retrieved from the program memory 20, receives and transmits data, and generally manages the overall operation of the device 10.

The GPS component 14 is preferably an integrated circuit based GPS chipset which includes a receiver and microcontroller. The GPS chipset may be a single, integrated microchip, or multiple microchips such as a processor and a separate receiver which are operably coupled to each other (for example, on a printed circuit board (“PCB”)). For instance, the GPS component 14 may be a NJ1030 GPS chipset available from Nemerix, Inc., or any other suitable GPS chipset or microchip. The GPS component 14 preferably includes a GPS receiver, associated integrated circuit(s), firmware and/or software to control the operation of the microchip, and may also include one or more correction signal receiver(s) (alternatively, the correction signal receiver(s) may be integrated into a single receiver along with the GPS receiver). As is well known, the GPS component 14 receives signals from GPS satellites and/or other signals such as correction signals, and calculates the positional coordinates of the GPS component 14. The device 10 utilizes this positional data to calculate and display distances to features or selected locations on a golf course, as described in more detail below.

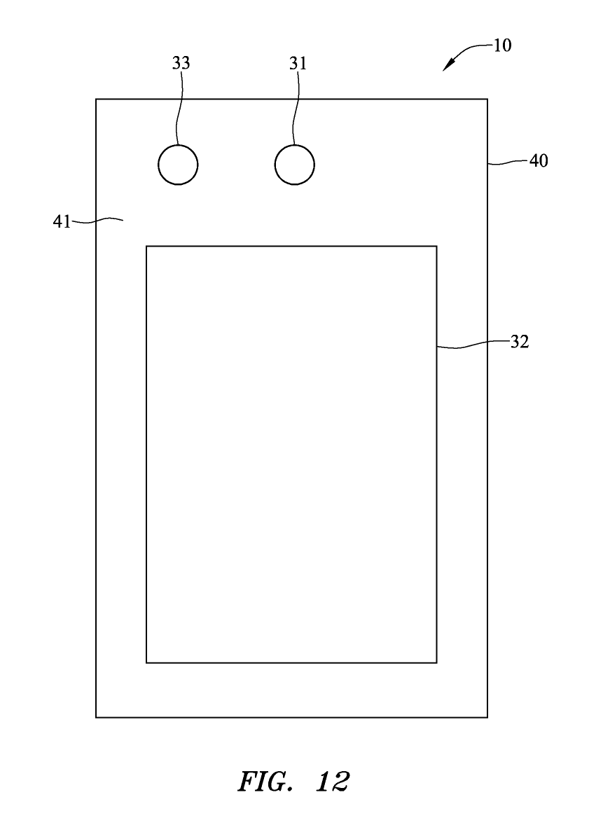

The laser component 13 preferably comprises a pulsed laser diode. One such pulsed laser diode is a NANOSTACK pulsed laser diode available from Osram of Regensburg, Germany. The NANOSTACK pulsed laser diode has a laser wavelength of 850 nanometers, an optical peak power up to 10 Watts, is capable of short laser pulses from 1 to 100 nanoseconds, and has a laser aperture of 200 microns×2 microns. Those skilled in the pertinent art will recognize that other laser diodes may be utilized as part of the laser component without departing from the scope and spirit of the present invention. The laser component 13 also has a laser receiver 32, as shown in FIG. 12, which is preferably a photodetector for detecting the reflected laser beam from the laser diode.

The camera component 15 is preferably high definition, five-Megapixel or greater, CMOS image sensor camera such as available from APTINA IMAGING of San Jose, Calif. Such a camera has a 5-megapixel resolution, a data rate of 96 Mp/s, a responsivity of 1.4 V/lux-sec and a 12-bit progressive scan.

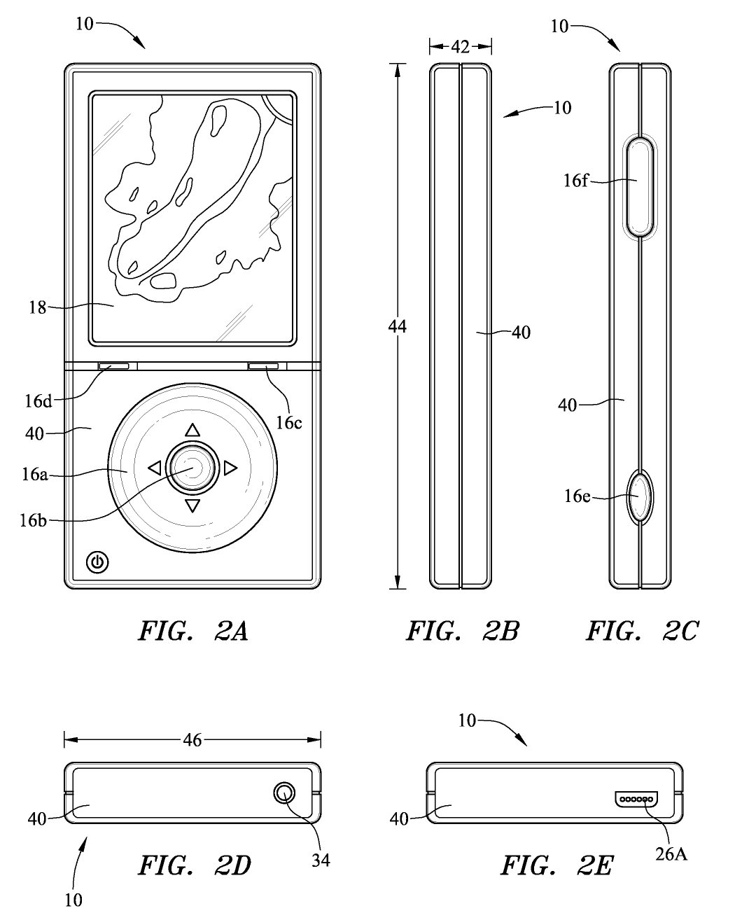

The display component 18 may be any suitable graphic display, but is preferably a high resolution (e.g. 320 pixels by 240 pixels, QVGA or higher resolution), full color LCD. The display component 18 is preferably the largest size display that can be fit into the form factor of the overall device 10, and preferably has a diagonal screen dimension of between about 1.5 inches and 4 inches. For example, for the form factor described below with reference to FIG. 2, the display may be a 2.2″ diagonal, QVGA, full color LCD. In addition, since the display 18 is intended to be used outside under sunlit conditions, the display component 18 should provide good visibility under brightly lit conditions, such as with a transflective LCD.

The program memory 20 stores at least some of the software and data used to control and operate the device 10. For example, the program memory 20 may store the operating system (such as LINUX or Windows CE), the application software (which provides the specific functionality of the device 10, as described below), and location data. The program memory 20 broadly includes all of the memory of the device 10, including memory contained on the microprocessor, memory in a non-volatile memory storage device such as flash memory, EPROM, or EEPROM, memory on a hard disk drive (“hdd”), SD Card(s), USB based memory devices, other types of flash memory, or other suitable storage device, including one or more electronic memory devices on the device, including an additional removable memory unit.

The user input device 16 may comprise a plurality of buttons, a touch screen, a keypad, or any other suitable user interface which allows a user to select functions and move a cursor. Referring to the embodiment shown in FIG. 2, an example of a user input device comprises a directional pad 16a and plurality of buttons 16b, 16c, 16d, 16e and 16f. The device 10 is configured such that directional pad 16a may be used to move a cursor around the display, while the buttons 16b-16f may be used to make selections and/or activate functions such as activating the voice recognition or switching between modes (as described in more detail below).

In order to provide portability, the device 10 is preferably battery powered by a battery and power management unit 28. The battery may be any suitable battery, including one or more non-rechargeable batteries or rechargeable batteries. For instance, a rechargeable, lithium-ion battery would work quite well in this application, as it provides relatively long life on a single charge, it is compact, and it can be re-charged many times before it fails or loses significant capacity. The power management unit controls and distributes the battery power to the other components of the device 10, controls battery charging, and may provide an output representing the battery life. The power management unit may be a separate integrated circuit and firmware, or it may be integrated with the processor 12, or other of the electronic components of the device 10.

The data transfer interface 26 is configured to send and receive data from a computer or other electronic device (e.g. another device 10). The interface 26 may be a physical connection such as a USB connection, a radio frequency connection such as Wi-Fi, wireless USB, or Bluetooth, an infra-red optical link, or any other suitable interface which can exchange electronic data between the device 10 and another electronic device. As shown in one preferred embodiment in FIG. 2, the interface 26 comprises a USB connection having a USB connector 26a.

The electronic components of the device 10 are preferably assembled onto a PCB, along with various other electronic components and mechanical interfaces (such as buttons for the user input device 16), thereby providing the electronic connections and operability for a functional electronic device 10.

Turning to FIG. 2 now, the device 10 preferably comprises a housing 40 which houses the electronic components such that the entire device has a very compact, thin, and lightweight form factor. The housing 40 may be formed of any suitable material, but is preferably a plastic material which is substantially transparent to radio frequency signals from GPS satellites. Indeed, the device is preferably handheld and small enough to fit comfortably in a pocket of a user's clothing. One example of the form factor for the device 10 with dimensions is shown in FIG. 2. In one preferred form, the device 10 may have the following dimensions: a height 44 of about 4 inches or less, a width 46 of 1.9 inches or less and a thickness 42 of 0.6 inches or less. More preferably, the height 44 is 3.9 inches or less, the width 46 is 1.8 inches or less, and the thickness 42 is 0.55 inch or less. The entire device 10 may weigh about 3.5 ounces or less, including the battery 28.

An application software program is stored in the program memory 12. The application software program is configured to operate with the processor 12 and the other electronic components to provide the device 10 with the functionality as described herein.

In a preferred embodiment, the device 10 is utilized to locate distances on a golf course. Alternatively, the device 10 is utilized for hiking to determine distances in the wilderness. Still further, the device 10 is integrated with a smart phone or a mobile phone to be utilized for finding numerous distances. For example, the device 10 may work with GOOGLE maps to plot distances within an urban area or a rural area.

For the preferred embodiment, the golf courses are mapped to create the golf course data using any suitable method, such as ground survey, or more preferably, by using geo-referenced satellite or aerial images. The mapping process produces golf course data which can be used by the device 10 to determine the coordinates of golf course features of interest, such as the greens, bunkers, hazards, tees, pin positions, other landmarks, and the like. Generally, the perimeter of the golf course features will be mapped so that distance to the front and back of the feature may be determined. The mapping process can be done quickly and easily by displaying the geo-referenced images of the golf course on a computer and then using a script (or other software) each feature of interest is traced (or a series of discrete points on the perimeter may be selected). The captured data is then used to create a data set comprising the coordinates for a plurality of points on the perimeter of the feature, or a vector-map of the perimeter, or other data, which can be used to calculate the distance to such feature from the location of the device 10. The golf course data preferably also includes golf hole data such as par, handicap, daily tee and hole locations, etc. In addition, for use with the “Pro Mode” as described below, the golf course data may include geo-referenced photographic course images, such as satellite or aerial photographs and/or video images. Indeed, the golf course data package for operating the device 10 in the Pro Mode and the Basic Mode is substantially the same, except that the Pro Mode data package includes the graphical images of the golf course. In other words, the golf course data related to the feature locations is exactly the same for both the Pro Mode and the Basic Mode, and the device 10 is configured to utilize this data with or without the graphical images. Thus, advantageously, creation of the Pro Mode data package also creates the Basic Mode data set.

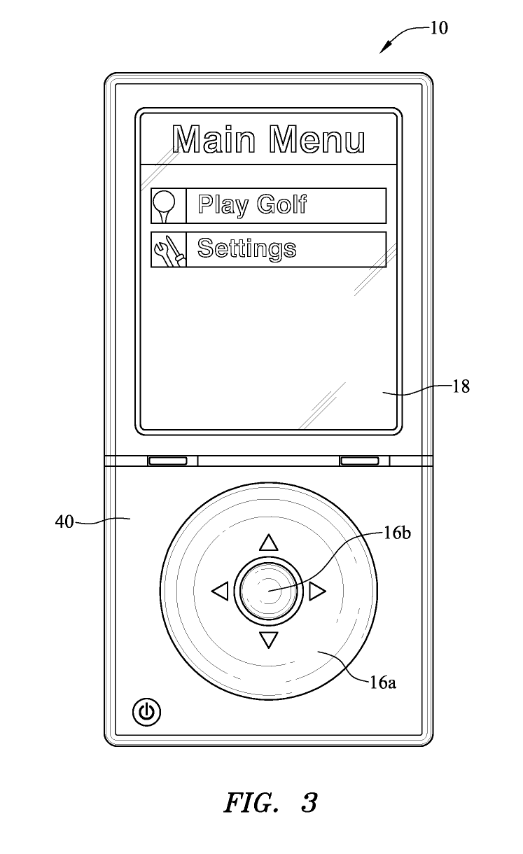

With reference now to FIGS. 3-11, the operation and functionality of the device 10 according to one embodiment will be described. Referring to FIG. 3, a “Main Menu” screen is displayed on the display 18. The “Main Menu” screen has two options, “Play Golf” or “Settings.” The choices on the Main Menu screen (or any of the other menus and screen displays described herein) can be selected by changing the highlighted option using the up and down arrows on the directional pad 16a of the user input device 16. The button 16b may function as an “Enter” key to make a selection. If a touch screen input device 16 is utilized, the user can simply touch the selection on the display 18.

Selecting “Settings” will bring up a “Settings” menu which allows the user to set various device and player settings and preferences. For example, the “Settings” menu may allow the user to set such user preferences as system units (e.g. yards or meters), preferred display settings (e.g. text size, Pro Mode vs. Basic Mode, screen brightness and contrast), turning on/off functions (such as score keeping, voice recognition, shot tracking, etc.), and other device settings.

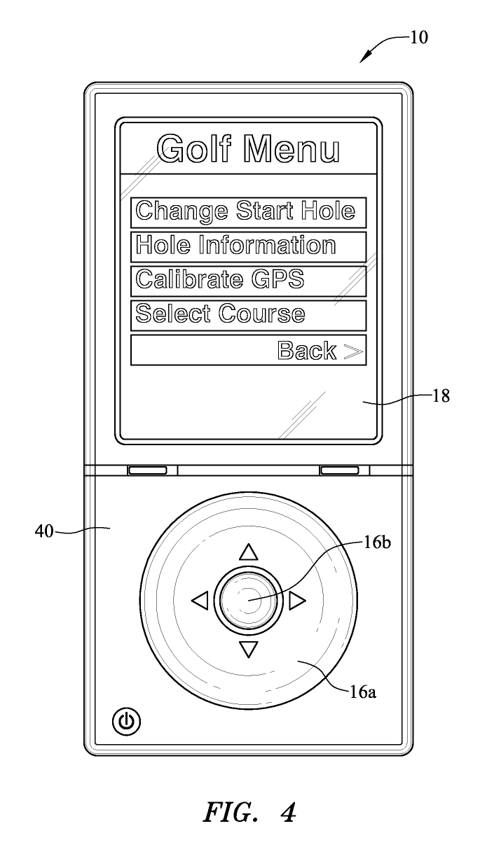

Selecting the “Play Golf” mode brings up a “Golf Menu” as shown in FIG. 4 for initializing the GPS device 10 for use during a round of golf. The course being played may be selected by selecting “Select Course” which may bring up a list of courses currently stored on the device 10. The list of courses shown can be determined based on the location of the device as determined by the device 10, for example, a list of the two or three courses closest to the location of the device. Alternatively, the list can be generated as a simple alphabetical list, a list of favorites, or other suitable listing method. The “Golf Menu” also allows the user to choose the starting hole, for instance, if a player is going to start on a hole other than the 1st hole, such as starting on the 10th hole (the “back nine”).

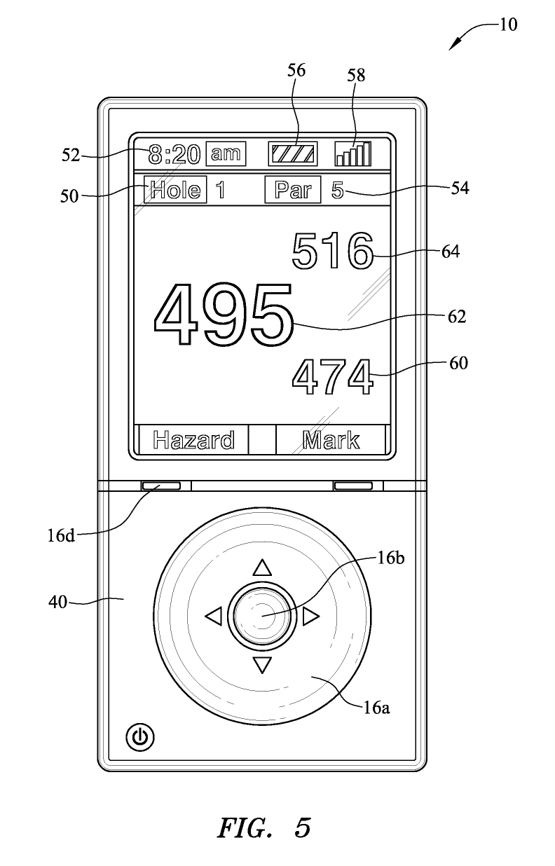

Once the course and starting hole have been selected, the device 10 determines the location of the device 10 using the GPS chipset 14, and then displays various golf hole information on the display. Turning to FIG. 5, in this described embodiment, the device 10 is configured to display the hole number 50, the current time 52 (the device 10 may include a clock function which can be provided by the microprocessor 12, the GPS chipset 14, or other electronic device), the par for the hole 54, a battery charge indicator 56, and a GPS signal strength indicator 58. The device 10 further calculates the distance between the determined location of the device 10 and the front, middle and back of the green and displays the distance to the front 60, the middle 62 and the back 64 of the green. As the device 10 is moved, the location of the device 10 is continually updated, and the distances (such as the front 60, middle 64, and back 64 of green) displayed are updated accordingly.

The device 10 may also be configured to display a video flyover of the hole being played using a satellite or aerial photographic images of the hole. The device 10 may be configured to automatically display the flyover when the device 10 detects that the device 10 is approaching or has reached a particular hole, and/or the user can select to display the flyover using the menu-driven selections.

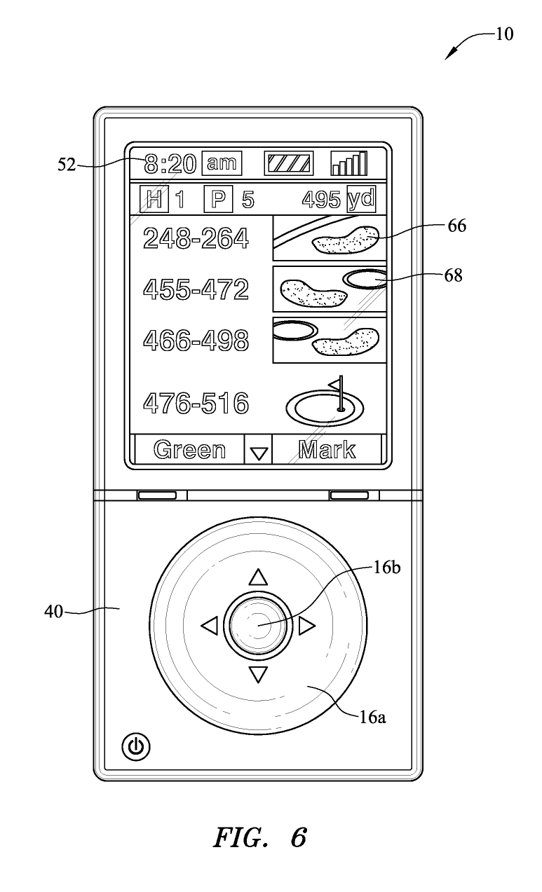

The device 10 also may display the distances from the location of the device 10 to hazards and other features of interest as shown in FIG. 6. As an example, the user may select the “Hazard” selection on the display shown in FIG. 5 using the button 16d to bring up the screen as shown in FIG. 6. The screen shown in FIG. 6 displays the “Hazard” information in what is referred to herein as “Basic Mode.” Basic Mode displays the “Hazard” information in a list using icons or text and respective measured distances. The example of FIG. 6 shows an icon for a right fairway bunker 66 and the distance to the front side of the bunker is 248 yards and the distance to carry the bunker is 264 yards. Similarly, the screen shows that the distance to the left greenside bunker 68 is 455 yards to reach and 472 yards to carry. Instead of easy to read icons, the features can alternatively be displayed using text, such as “Right Fairway Bunker” or using an abbreviation such as RtFwyBnkr, or the like.

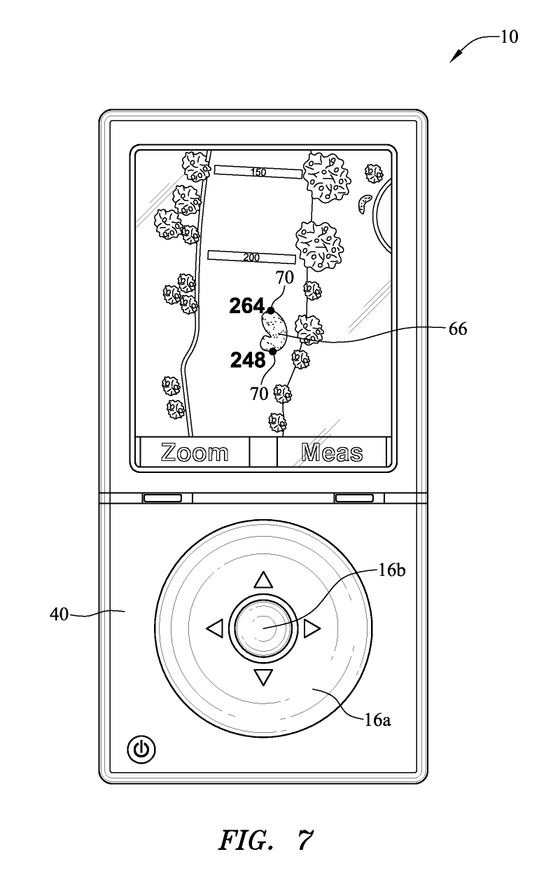

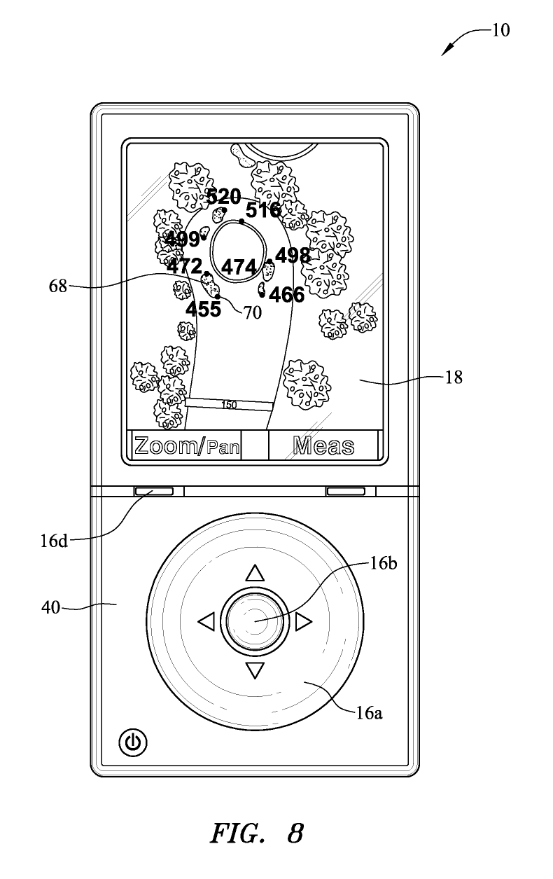

As described above, the device 10 may be configured to display the golf hole information in two distinct operating modes. The first mode is the Basic Mode which displays the distances and features in a text and/or icon format. In the second mode, referred to herein as the Pro Mode, the distances and features are shown on the display on a graphical image of a relevant area (also referred to as a “viewport”) of the golf course. Examples of the Pro Mode showing the same information as the display shown in FIG. 6 are shown in FIGS. 7 and 8. The graphical image is preferably a photographic image generated from geo-referenced (e.g. coordinates are available for substantially any location on the image) satellite or aerial digital photographs, or geo-referenced, generated images. In Pro Mode, the images of the features, such as bunkers, the green, water hazards, etc. are displayed in the photographic image and the distances are overlaid onto the image. A distance marker 70, such as a red dot or other small but easily viewable symbol, is placed on the feature at the exact point of measurement, and the distance number is displayed in close proximity to the marker 70. Referring to the example of FIG. 7, the right fairway bunker 66 is 248 yards to reach and 264 yards to carry. This is exactly the same distance information shown in the display depicted in FIG. 6. Likewise, as shown in FIG. 8, the left greenside bunker 68 is 455 yards to the front and 472 yards to the back.

As explained above, the golf course data for both the Pro Mode and the Basic Mode is the same, except that the golf course images are required for the Pro Mode. Thus, if the Pro Mode course data has been loaded onto the device, the device is configured such that it can toggle back and forth between the Pro Mode display and the Basic Mode display. One of the buttons, such as button 16e or 16f (see FIG. 2), may be set up to toggle between the Pro Mode and the Basic Mode. However, if only the Basic Mode course data has been loaded onto the device, only the Basic Mode information may be displayed.

While viewing a list of features in Basic Mode, a feature may be selected, such as by scrolling through the list of features as shown in FIG. 6, and the user may select to view the Pro Mode display of such feature simply by selecting the feature from the list and selecting the Pro Mode. Of course, this feature would only be available if the Pro Mode course data has been loaded onto the device.

In order to optimize the viewability of the golf course images and displayed distances in the Pro Mode on a relatively small display 18, the device 10 may include a automatic, dynamic, viewport generation method. The ability to miniaturize the size of the device 10 is in many ways limited by the size of the display 18, the major tradeoff being the desire to maximize the size of the display 18 in order to be able to display as much information and images at an easily viewable scale, while at the same time keeping the overall size of the device 10 as small as possible. Intelligent generation of the of the images and numbers being displayed can help to display the most relevant section of the golf hole being played with distances displayed at a font size that is easily readable.

The viewport generation may include one or more methods to determine the displayed viewport. First, the viewport generation method may include a method of determining the location and scale of the image of the golf course to be displayed based on the location of the device (and therefore the location of play) and the characteristics of the golf hole. For example, the method of viewport generation method displays the section of the golf hole that will be most relevant to the golfer from the current location, which may be a yardage range such as the fairway which is between 150 and 250 yards from the current location. As one specific example, FIG. 7 shows a viewport which might be displayed if the user is on the tee box of the displayed hole. The viewport displays the fairway and area surrounding the fairway from about 200 yards to 375 yards from the tee. The graphic image is automatically scaled (i.e. the zoom level is set) to display the relevant section of the hole so that it will fit on the display while maintaining viewability of relevant features (e.g. the bunkers) and distance to the fairway bunker. If the hole happens to be a par 3, or there is less than a certain distance (e.g. 250 yards) to the end of the hole, then the viewport generation method may display the rest of the hole at a maximum zoom level that can fit the rest of the hole on the display (see e.g. FIG. 8).

In another method of viewport generation, the distances displayed may be adjusted to avoid overlapping. This method may also be referred to as collision management. At certain zoom levels, for example very low zoom levels, many features as displayed on the display may be very close together such that if all of the distances to these features are displayed the numbers will overlap and the readability of the information will be compromised. To avoid this, the method will not display some of the distances so as to avoid any overlapping distances. The determination of the distances which will not be displayed, so as to avoid overlap, may be determined based on a hierarchy of the features, a random determination, a predetermination contained in the course data, an algorithm which determines the most important distances, some other criteria, or a combination of these methods. In another aspect of this feature, the method can be configured such that the user may select to display some or all of the non-displayed distances in which case the previously displayed distances which overlap these non-displayed distances are turned off. This selection may be a toggle, so that the user can toggle back and forth between the distances displayed. If there are more than two distances which would conflict with each other if displayed simultaneously, this user selection can advance through each of the non-displayed distances until all of the distances can be displayed sequentially, while the other conflicting distances are turned off.

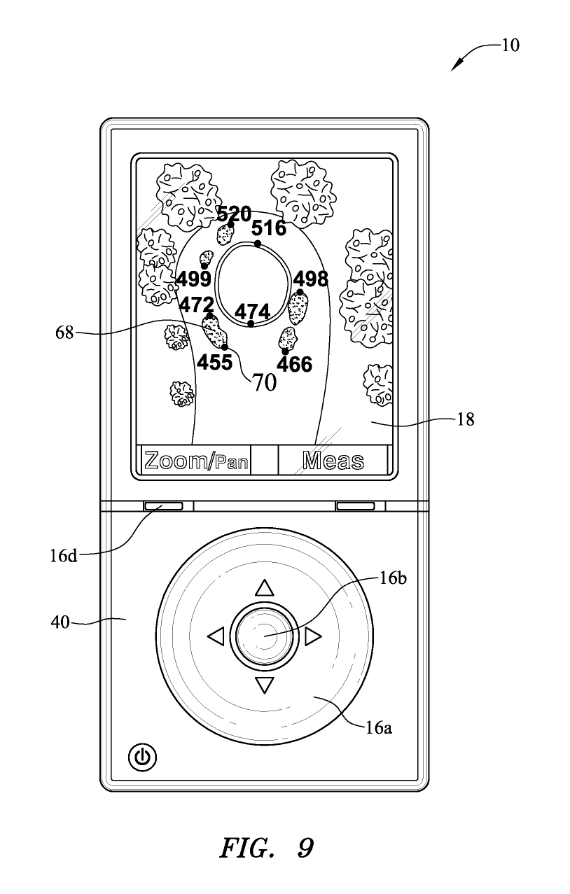

The device 10 may also pan and zoom the displayed graphical images of the golf course with the distance overlays in Pro Mode. Referring to FIG. 8, an example of a green view at a low zoom level is shown. The device 10 is shown in “Zoom” mode which is indicated by the “Zoom/Pan” toggle selection at the bottom left corner of the display 18. To zoom “in” on the image being displayed, the “up” arrow on the directional pad 16a is pushed, as shown in FIG. 9. To zoom “out”, the “down” arrow on the directional pad 16a is pushed. The device 10 may be configured such that holding down the “up” or “down” arrow will continue to zoom “in” or “out,” respectively. To switch to “Pan” mode as shown in FIG. 9, the button 16d is pushed. The user can pan the displayed image by pressing the desired direction of pan on the directional pad 16a. When zooming or panning, the distances again remain overlaid at the correct locations next to their respective features (or feature marker) and at the pre-set font size.

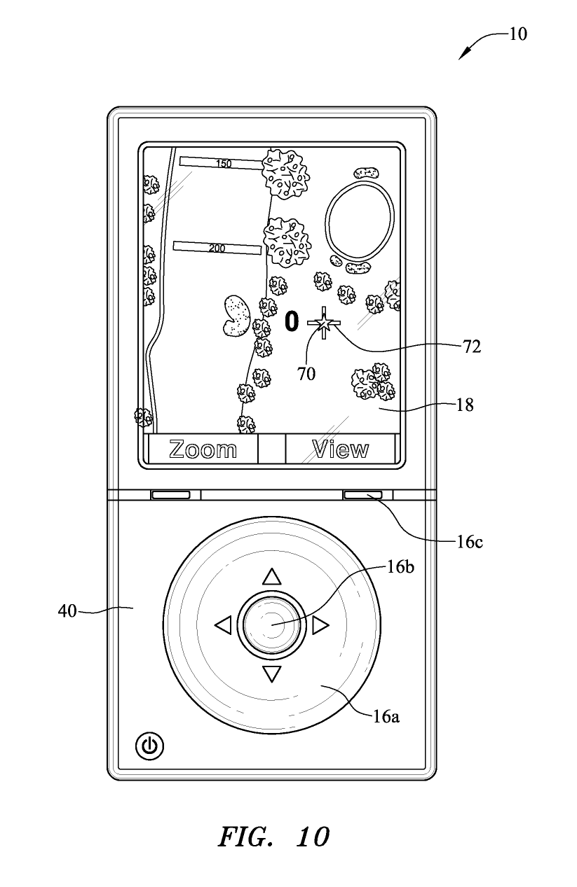

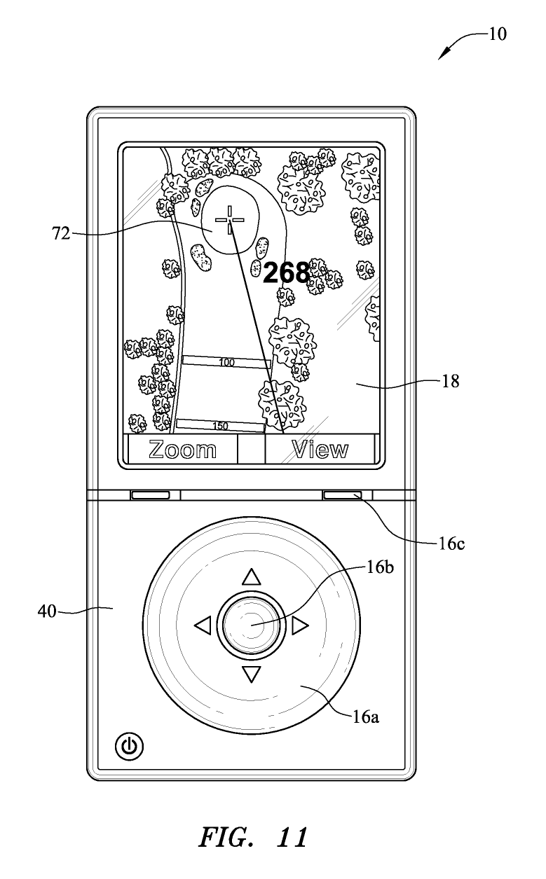

The device 10 may also be configured to measure the distance between locations on the golf course using the images displayed on the display. In order to measure a distance from the location of the device to a location as viewed on image on the display, the “Meas” button 16c is selected (see FIG. 9), to enter “Measure” mode as shown in FIG. 10. A cursor 70 (such as a “+”) and a marker 72 (such as the star shown in FIG. 10) will appear at the current location of the device 10. The marker 70 indicates the current location of the device 10, and the cursor indicates the point being measured to. At the outset, the marker 70 and cursor 72 are at the same location, so the distance is displayed as “0”. The directional pad is then used to move the cursor 72 to the location of interest. As the cursor 72 is moved, the distance between the cursor 72 and the marker 70 is calculated and displayed. As the cursor 72 reaches the edge of the display in the direction of interest, the display may automatically pan (and/or zoom), as shown in FIG. 11. When the cursor is located at the location of interest, the desired distance will be displayed, as shown in the example of FIG. 11. In a similar manner, the device 10 may also be configured to measure the distance between two locations of interest selected on display. The user simply selects the “Meas” mode. The cursor 72 is then positioned at a first point of interest, the button 16b is pushed to set the first point of interest, and then the cursor 72 is moved to a second point of interest. As in the example above, the distance between selected first point of interest and the location of the cursor will be updated and displayed as the cursor is moved. The distance between a first location for the device 10 and a second location of the device 10 may also be measured by simply entering the “Meas” mode and then moving the device 10 to a new location. As the device 10 is moved, the distance between the original location of the device 10 and the new location of the device 10 will be calculated and displayed. The pan and zoom functions may be utilized automatically or manually during any of the above described measurement modes in order to select a location of interest. In other words, as the cursor reaches the edge of the viewing area, the image will pan (and/or zoom “out”) to display a portion of the image that was previously outside the viewing area.

In order to improve the accuracy of the device, the device 10 also includes a calibration method which corrects for local errors in the GPS system. Because the golf course images utilized on the device 10 are accurately geo-referenced with global coordinates, every discernable feature on the golf course images is a potential calibration point. To perform the calibration, referring to FIG. 4, the “Calibrate GPS” mode is selected. The use then locates a physical feature at the golf course which can also be fairly accurately identified and located on a graphical image of the same physical feature shown on the display of the device 10. As examples, the calibration feature may be a cart path intersection, a distinctive shape of a bunker, a manhole cover, or a permanent tee marker. The device 10 is then placed at the physical feature, and then the user places a cursor shown on the display of the device onto the image of the same physical feature. It may be helpful to zoom in to a high zoom level or even the maximum zoom level of the physical feature to improve the precision of the location of the cursor. The device 10 then determines the offset between the apparent location measured by the device 10 and the location of the physical feature on the displayed image. The resultant offset is then used to correct all the GPS readings for the round of golf.

The device 10 of the present invention may also be configured to present a pre-round preview of a golf course. The device 10 allows the user the load a desired golf course and then navigate around the course, such as hole by hole. The preview may include a display of each hypothetical shot which might be take for each hole and/or suggested strategy for playing each hole and/or shot. For instance, the preview mode may display pre-loaded hypothetical shots which are automatically generated or contained within a golf course data package; or the preview mode may use distances typical of the user's club distances, or a distance as selected by the user for each shot, to perform a shot-by-shot preview.

Similar to the pre-round preview feature, the device 10 may be configured to track each shot taken by the user during a round of golf, including the club used for each shot and other shot information (such as quality and condition of lie, degree of swing such as full shot, half shot, etc., quality of contact, ball flight, etc.). At each ball position during a round of golf, the device 10 is configured to receive an input of the shot information and store the shot information referenced to the location of the device 10. With this stored information, the device 10 may also be configured to play back a round of golf which was tracked using the device, and/or download the tracked round to a computer or other device for playback and/or analysis.

As shown in FIG. 12, the second surface 41 of the housing 40 of the device preferably includes a laser receiver 32, an aperture 31 for the light source of the laser component 13, and a viewing lens 33 for the camera component 15. The area of the laser receiver is preferably maximized in order to receive the reflected beam from the light source.

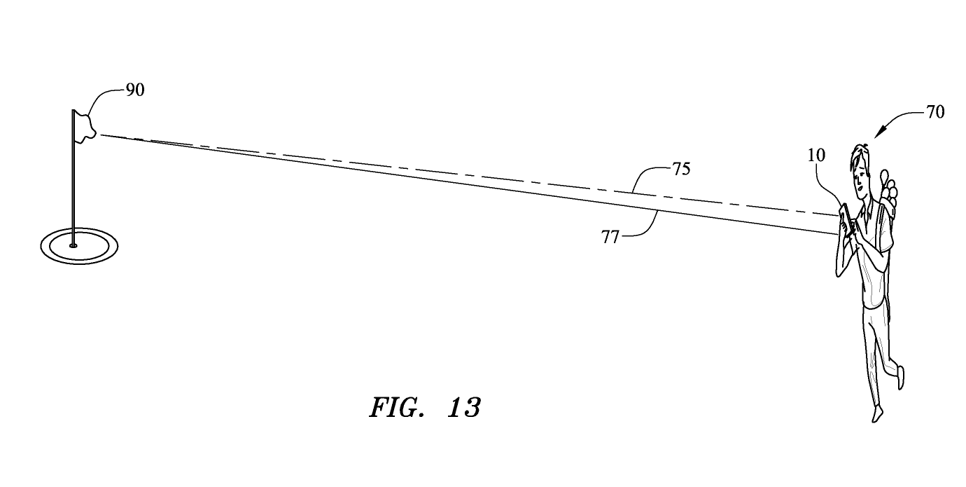

As shown in FIG. 13, a golfer 70 “shoots” a laser beam 75 at a flagstick 90 and receives a reflected beam 77 from which the distance from the device 10 to the flagstick 90 is determined for display on the display component 18.

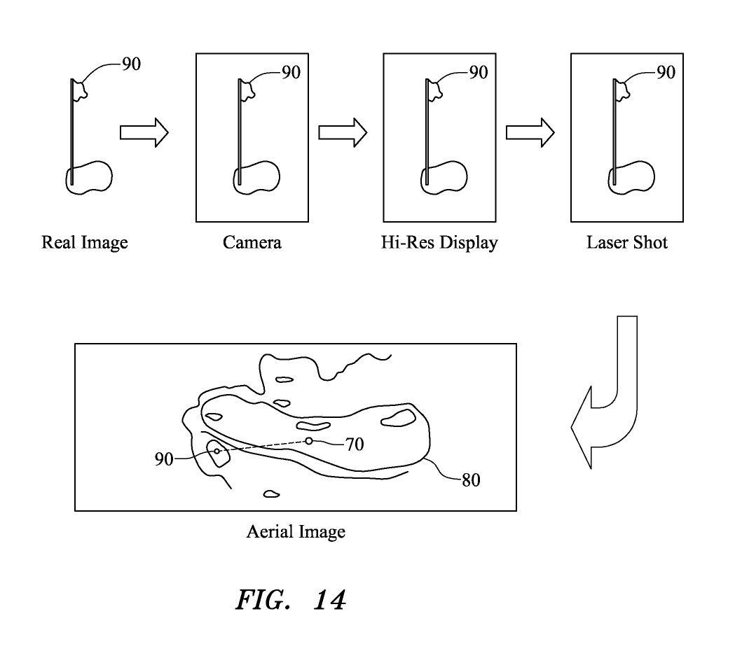

As shown in FIG. 14, a real image of a flagstick 90 is then viewed using the camera component 13 which enhances the view which is placed on the high resolution display of the display component 18 in order to more easily aim the laser component for determining the distance from the device 10 to the flagstick 90, which is then transferred to an aerial image of a golf course 80 using information from the GPS component along with distance information from the laser component.

The foregoing illustrated and described embodiments of the invention are susceptible to various modifications and alternative forms, and it should be understood that the invention generally, as well as the specific embodiments described herein, are not limited to the particular forms or methods disclosed, but also cover all modifications, equivalents and alternatives falling within the scope of the appended claims. The invention, therefore, should not be limited, except to the following claims, and their equivalents.

1. A portable golf GPS device having a distance locating function, the device comprising:
a housing having a first surface and a second surface, the second surface opposing the first surface, the housing having a height of no more than 4 inches, a width of no more than 1.9 inches and a thickness of no more than 0.6 inch;
a GPS component dispersed within the housing, the GPS component comprising a GPS receiver and an antenna, the GPS component determining a location of the device;
a camera component comprising a lens positioned at a first opening in the second surface of the housing, the camera component enhancing a viewing of a flagstick located on a green of a hole of a golf course, the camera component having a five megapixel or greater resolution;
a laser component comprising a light source and a receiver, the receiver located on the second surface, the light source comprising a pulsed laser diode having a wavelength of 850 nanometers, an optical peak power up to 10 Watts, and capable of short laser pulses from 1 to 100 nanoseconds, the light source transmitting a beam of light through a second opening in the second surface of the housing, the laser component determining a distance from the device to the flagstick on the green;
a memory within the housing comprising a plurality of aerial images of portions of golf courses, at least one of the plurality of aerial images including the flagstick on the green;
a single display component disposed on the first surface of the housing, the single display component displaying images from the camera component and the plurality of aerial images, the single display component having a diagonal screen dimension ranging from 1.5 inches to 4.0 inches;
a processor, the processor in electrical communication with the camera component, the laser component, the memory, the single display component and the GPS component; the processor configured to display on the single display component the flagstick on the green on the at least one aerial image based on the location of the device from the GPS component and the distance to the flagstick on the green obtained from the laser component; and
a power source for providing power to the processor, the camera component, the laser component, the display component, the memory, and the GPS component.
